(19) United States
(12) Patent Application Publication
(10) Pub. No.: US 2017/0347527 A1
(43) Pub. Date: Dec. 7, 2017

(54) DEVICE FOR PICKING-UP BALES OF HAY FROM THE GROUND AND MACHINE FOR PICKING-UP BALES OF HAY INCLUDING SAID DEVICE

(71) Applicant: ARCUSIN, S.A., Vilasana (ES)

(72) Inventor: Manuel Cusine Barber, Vila-Sana (ES)

(21) Appl. No.: 15/609,597

(22) Filed: May 31, 2017

(30) Foreign Application Priority Data
Jun. 1, 2016 (ES) P201630720

(51) Int. Cl. A01D 87/12; A01D 90/08; B60P 1/43; B60P 1/52

(52) U.S. Cl. CPC A01D 87/12; B60P 1/52; A01D 90/08; B60P 1/43

(57) ABSTRACT

It comprises first traction means (8) of the bales (2) and dragging means (5a, 5b) of said first traction means (8) disposed to transport the bales (2) along an upward inclined plane (4) to a loading platform, and it is characterized in that it comprises second traction means (9) of the bales (2) configured to contact the bales (2) at ground level (13) in a advanced attack position with respect to the first traction means (8), said device (1) including dragging means (6a,6b) of said second traction means (9) disposed to lift the bales (2) from the ground (13) and transport said bales (2) until making contact with the first traction means (8).

The present invention relates to a device for picking-up forage bales from the ground of inclined plane-type, and to a machine for picking-up forage bales including said device.

### BACKGROUND OF THE INVENTION

The systems for picking-up forage bales from the ground can be of different types. Some systems include a grip to fasten a bale on the ground by its sides and lift the bale to the loading platform. Other systems include hooks that are stuck into the bale for picking-up and raising it to the platform. Finally, inclined plane systems exist including traction spikes of the bales and dragging chains of said traction spikes disposed to transport the bales along an upward inclined plane to a loading platform.

Spanish patent ES203760B1 discloses a bale pick-up system of inclined plane-type wherein the traction spikes are placed close to the ground to contact the bales at an attack height that allows the bales to rise to the inclined plane of the dragging chains, following the forward direction of these chains.

The pick-up systems of inclined plane-type have the drawback that the bales must overcome a considerable step to rise to the dragging plane where the traction spikes are found actuated by the chains. This step hinders the raising of the bales, with the effort that the traction spikes must exert at a certain height from the ground to lift the bales being important. This is translated into very significant wear and, often, a breakage in the spikes or dragging chains.

### DESCRIPTION OF THE INVENTION

The objective of the present invention is to provide a device for picking-up forage bales from the ground of inclined plane-type, which resolves the indicated drawbacks, having the advantages described below.

In accordance with this objective, according to a first aspect, the present invention provides a device for picking-up bales deposited on the ground comprising first bale traction means and dragging means of said first bale traction means arranged to move the bales along an upward inclined plane to a loading platform, and it is characterized in that it comprises second bale traction means configured to contact the bales at ground level in an advanced attack position with respect to the first bale traction means, and said device including dragging means of said second bale traction means arranged to lift the bales from the ground and move said bales until the first bale traction means.

According to a second aspect, the present invention provides a machine for picking-up bales from the ground comprising the device claimed and a loading and/or storage platform of the bales of hay picked up by said device.

The device of the present invention has the advantage that it combines first and second traction means with differentiated functions that contact the bales in two different attack positions. The first traction means are associated to dragging means disposed to transport the bales along an inclined plane, whilst the second traction means are associated to dragging means disposed to lift the bales at ground level and transport the bales until the first traction means. In particular, the second traction means have been configured so that they can contact the bales at ground level in an advanced attack position with respect to the first traction means. Thanks to this, the step that the bales must overcome to rise to the dragging plane of the first traction means is very reduced, which makes bale pick-up gentler, reduces the loss of hay due to friction in the lifting, avoids impact of the bale on the inclined plane and significantly reduces the wear and tear of the device.

It has been observed that, when the second traction means contact the bale at ground level, the force necessary to lift the end of the bale and raise the bale to the inclined dragging plane is less. In the devices of the state of the art, the traction means contact the bale at a higher attack height, so that the force that these means must to raise the bales to the inclined dragging plane is also greater.

Preferably, said device comprises at least a first dragging chain of said first bale traction means mounted on a frame so that it defines an upward inclined plane of the bales, and at least a second dragging chain of said second bale traction means which is mounted on the same frame so that occupies an advanced position in the inclined plane with respect to the first dragging chain. These dragging chains can be, for example, link chains.

According to a preferred embodiment, said device comprises at least two first dragging chains and at least two second dragging chains disposed parallel and alternately so that it defines an upward inclined plane of the bales wherein at least two second dragging chains occupy an advanced attack position with respect to another two first chains.

According to the same preferred embodiment, the second bale traction means comprise a plurality of bale contact elements configured with a length less than the length of the first bale traction means, and the dragging means of said contact elements being susceptible to be situated at ground level to lift and transport the bales until the first bale traction means. Advantageously, each one of these bale contact elements comprises gussets provided on parallel links of said second dragging chain, and a cross-bar which joins said gussets.

Preferably, the first bale traction means comprise a plurality of traction elements configured to fasten the bales whilst said bales are transported by dragging along the upward inclined plane to the loading platform. These traction elements can be, for example, traction spikes provided on the parallel links of said first dragging chain. Alternatively, instead spikes hooks of any type can be used or any element which can fasten the bale with force whilst it is transported along the inclined plane.

Advantageously, the device comprises means to actuate simultaneously the first and second dragging means and, preferably, said actuation means comprise at least two gear wheels for each one of said first and second chains, and the gear wheels of both chains are simultaneously actuated by a drive element disposed in the frame of the device.

Again advantageously, the diameter of the gear wheels of the second dragging chain is less than the diameter of the gear wheels of the first dragging chain. This smaller diameter of the gear wheels of the second chain can be achieved either by reducing the number of teeth of the wheels or by reducing the pitch of links of the chain.

In this way, as previously commented, the second dragging chain can be approximated at ground level to allow that contact elements lift the bale and they raise it to the inclined dragging plane with a minimum step.

### BRIEF DESCRIPTION OF THE FIGURES

For a better understanding of all that has been stated, drawings are attached wherein, schematically and only by way of non-limiting example, a practical embodiment has been represented.

FIG. 1 is a perspective view of an embodiment of the device of the present invention.

FIG. 2 shows a plan view of the device of FIG. 1 positioned in front of a bale of hay.

FIG. 3 shows a detail of the traction and dragging means of the device of FIG. 1.

FIG. 4 represents a pick-up sequence of the bale by means of the device of the present invention.

FIG. 5 represents a pick-up sequence of a bale of hay by means of a device of the state of the art.

### DESCRIPTION OF A PREFERRED EMBODIMENT

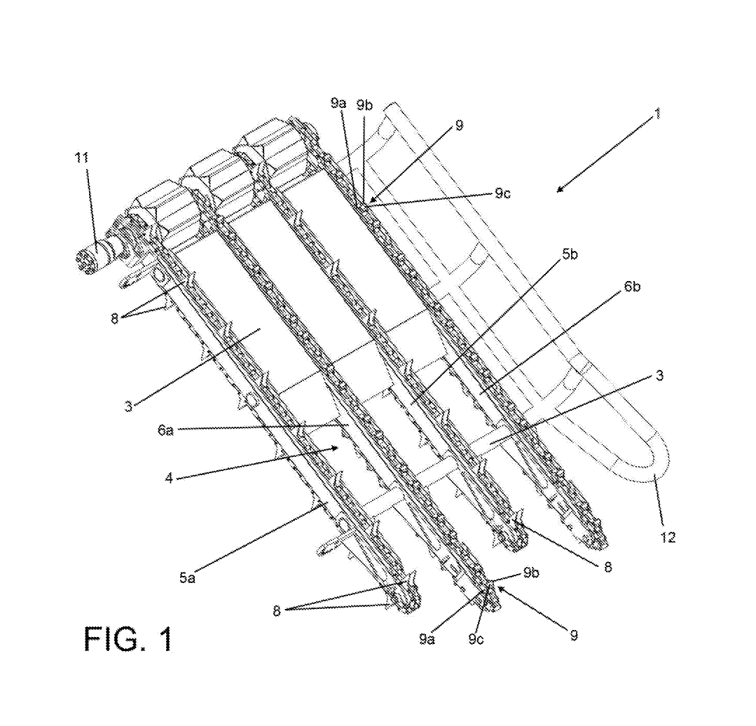

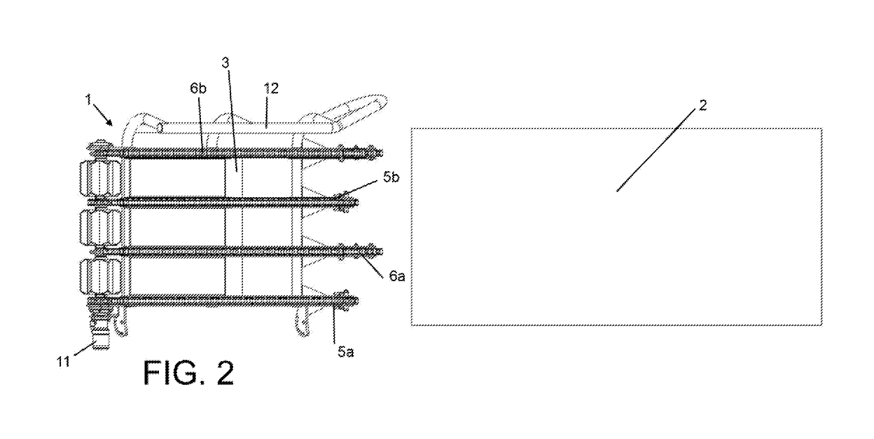

A preferred embodiment of the present invention is described below, making reference to FIGS. 1 to 5.

The pick-up device 1 of forage bales 2 of the present invention comprises dragging means configured by way of four dragging chains 5a, 5b, 6a, 6b, arranged in a frame 3 so that they define an upward inclined plane 4 of bales to a loading platform (not represented).

In the embodiment described, these dragging chains 5a, 5b, 6a, 6b are formed by links designed to gear in different gear wheels 7 simultaneously actuated by a motor 11 which is mounted on the frame 3 of the device 1. The frame 3 also has a lateral guiding element 12 disposed to direct and self-align the bales 2 in a forward direction to the loading platform (not represented) when said bales 2 are transported along the upward inclined plane 4.

As can be seen in FIG. 1, two of the four dragging chains, hereinafter second dragging chains 6a, 6b, are positioned in the inclined plane 4 in an advanced attack position with respect to the other two dragging chains, hereinafter first 5a, 5b dragging chains. The links of the first dragging chains 5a, 5b are provided with first traction means configured by way of a plurality of traction spikes 8 adapted to trap with force the bales 2 whilst said bales 2 are transported along the upward inclined plane 4. However, the links of the second dragging chains 6a, 6b are provided with second traction means configured by way of contact elements 9 with a length less than that of the traction spikes 8 to be able to contact the bales 2 at ground level 13 in the advanced attack position. In this way, the step 10 that the bales 2 must overcome to rise to the dragging plane 4 is very reduced, which also significantly reduces the wear and tear of the device 1.

Optionally, the pitch of the links of the second chains 6a, 6b which drag the contact elements 9, is less than the chain pitch of the links of the first 5a, 5b chains. In this way, the second chains 6a, 6b can be actuated by gear wheels 7 of smaller diameter, which makes it possible to approximate these chains 6a, 6b at ground level 13 so that the contact of the bale 2 with the contact elements 9 is carried out at an even smaller attack height from the ground 13. Alternatively, the diameter of the gear wheels 7 of the second chains 6a, 6b can be reduced by reducing the number of teeth of their gear wheels 7, instead of reducing the pitch of the chain links.

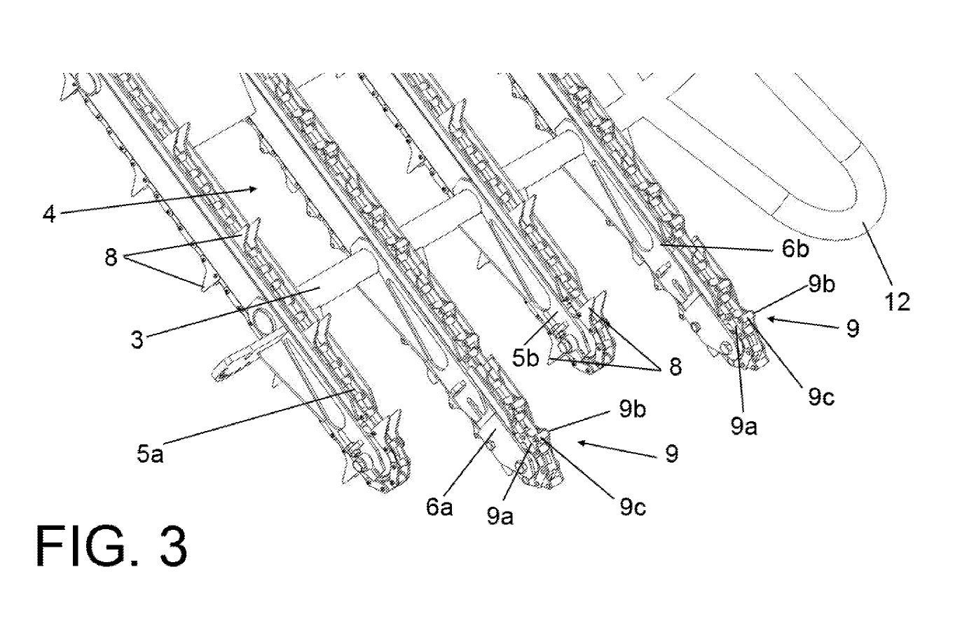

As can be seen in FIG. 3, in the embodiment described, the contact elements 9 of the second 6a, 6b dragging chains comprise each one, a pair of gussets 9a,9b provided on the parallel links of the second chains 6a, 6b and a cross-bar 9c which joins said gussets 9a,9b.

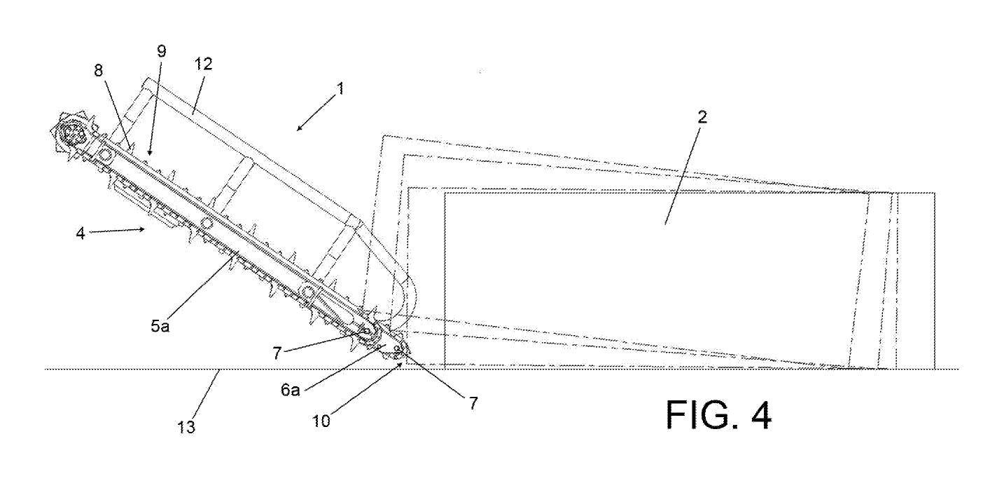

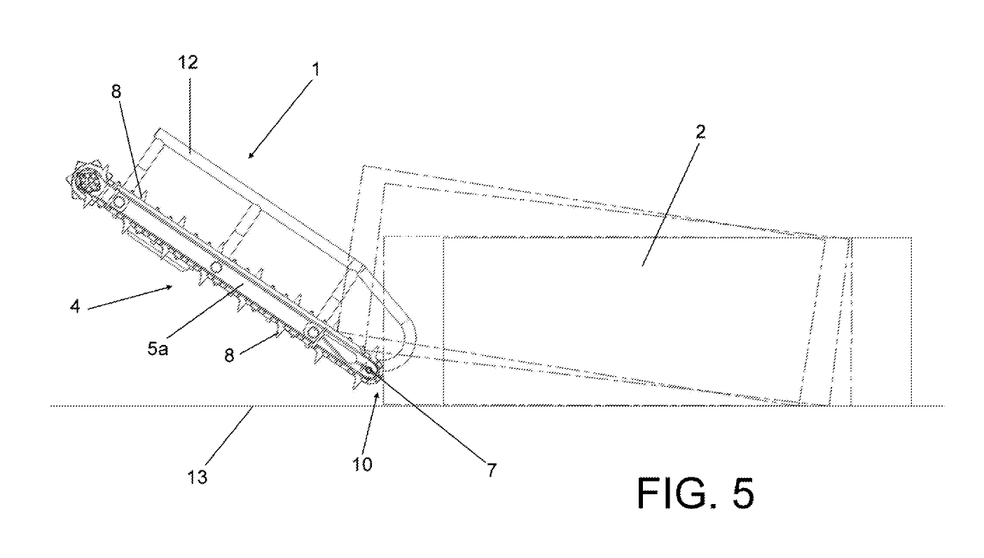

The operation of the device 1 of the present invention is described below, making reference to FIG. 4. FIG. 5 represents the operation of a device of the state of the art.

The device 1 of the present invention which shows FIG. 4 is situated in an attack position in front of a bale 2 of hay. For reasons of clarity, this device 1 has been represented without the tractor or dragging-truck wherein the device 1 is integrated. In this attack position, the contact elements 9 of the second 6a, 6b dragging chains contact with the bale 2 at ground level 13 in an advanced attack position with respect to the traction spikes 8, so that the step 10 the bale 2 must overcome to rise to the inclined plane 4 is minimum.

The advance of the second dragging chains 6a, 6b including the contact elements 9 causes the lifting of the bale 2 and its transport until making contact with the traction spikes 8 of the first dragging chains 5a, 5b which carry the bale 2 to the loading platform (not represented).

As can be seen in FIG. 4, the bale 2 is gradually lifted from a height positioned practically at ground level 13 due to effect of the gentle traction of the contact elements 9 that occupy an advanced attack position. Thanks to this, the force that the device 1 must exert is much less than that that the devices of the state of the art must exercise wherein the step 10 that the bale 2 must overcome to rise to the inclined dragging plane 4 is much greater (see FIG. 5).

Despite the fact that reference has been made to a specific embodiment of the invention, it is evident for a person skilled in the art that the device 1 described is susceptible to numerous variations and modifications and that all the details mentioned can be replaced by other technically equivalent ones, without departing from the scope of protection defined by the attached claims. For example, although an embodiment has been described with four dragging chains 5a, 5b, 6a, 6b, it would also be possible that the device included a different number of dragging chains, provided that at least one of the dragging chains was positioned in an advanced attack position with respect to the other chains to allow the contact of the bales 2 at ground level 13. Likewise, although the figures represent a device adapted for picking-up bales 2 of prismatic type, the same device could be adapted for picking-up bales of another type which was not prismatic. Also, even though in the description reference has been made to first and second dragging means comprising link chains, these dragging means could also comprise any other type of equivalent means that were adapted to pull the traction means that contact the bales 2. Furthermore, despite the fact that the embodiment that describes each one of the contact elements 9 of the bales includes gussets 9a, 9b joined by a cross-bar 9c, said contact elements 9 could comprise any other type of equivalent elements that were configured with a length less than the length of the traction spikes to allow the contact of the bales at ground level.

1. A device for picking-up bales deposited on the ground comprising first bale traction elements and dragging chains of said first bale traction elements arranged to move the bales along an upward inclined plane to a loading platform, wherein the device further comprises:
second bale traction elements configured to contact the bales at ground level in an advanced attack position with respect to the first bale traction elements; and
dragging chains of said second bale traction elements arranged to lift the bales from the ground and move said bales until making contact with the first bale traction elements.

2. The device according to claim 1, wherein said second bale traction elements comprise a plurality of bale contact elements configured with a length less than the length of the first bale traction elements, the dragging chains of said bale contact elements being able to be positioned at ground level to lift and move the bales until the first bale traction elements.

3. The device according to claim 1, wherein said first bale traction elements comprise a plurality of bale traction elements configured to fasten the bales while said bales are moved by dragging along the upward inclined plane to the loading platform.

4. The device according to claim 1, comprising at least a first dragging chain of said first bale traction elements mounted on a frame so that it defines an inclined plane of rising of the bales, and at least a second dragging chain of said second bale traction elements which is mounted on the same frame so that it occupies an advanced position in the inclined plane with respect to the first dragging chain.

5. The device according to claim 4, wherein said dragging chains are link chains.

6. The device according to claim 3, wherein said bale traction elements comprise traction spikes provided on parallel links of said first dragging chain.

7. The device according to claim 2, wherein each one of said bale contact elements comprises gussets provided on parallel links of said second dragging chain, and a cross-bar which joins said gussets.

8. The device according to claim 1, comprising a mechanism to actuate simultaneously said first and second dragging chains.

9. The device according to claim 4, wherein said actuation mechanism comprises for each one of said first and second chains at least two gear wheels, with the gear wheels of both chains being actuated simultaneously by a drive element arranged in the frame of the device.

10. The device according to claim 9, where the diameter of the gear wheels of the second dragging chain is less than the diameter of the gear wheels of the first dragging chain.

11. The device according to claim 1, wherein the frame whereon are mounted the first and second dragging chains comprises a lateral guiding element arranged to direct and self-align the bales in a forward direction when said bales are moved along the upward inclined plane to the loading platform.

12. A machine for picking-up forage bales from the ground comprising the device according to claim 1, and a loading and/or storage platform of the forage bales picked up by said device.

13. The device according to claim 5, wherein said bale traction elements comprise traction spikes provided on parallel links of said first dragging chain.

14. The device according to claim 5, wherein each one of said bale contact elements comprises gussets provided on parallel links of said second dragging chain, and a cross-bar which joins said gussets.

15. The device according to claim 8, where said actuation mechanism comprise for each one of said first and second dragging chains at least two gear wheels, with the gear wheels of both chains being actuated simultaneously by a drive element arranged in the frame of the device.

16. The device according to claim 15, wherein the diameter of the gear wheels of the second dragging chain is less than the diameter of the gear wheels of the first dragging chain.
